(19) United States
(12) Patent Application Publication
(10) Pub. No.: US 2011/0136028 A1
(43) Pub. Date: Jun. 9, 2011

(54) FUEL CELL SYSTEM AND CONTROL METHOD OF THE SAME

(75) Inventors: Nam Woo Lee, Hwasung (KR); Jae Jun Ko, Gunpo (KR); Sang Uk Kwon, Yongin (KR)

(73) Assignee: HYUNDAI MOTOR COMPANY, Seoul (KR)

(21) Appl. No.: 12/915,494

(22) Filed: Oct. 29, 2010

(30) Foreign Application Priority Data
Dec. 4, 2009 (KR) 10-2009-0120086

(51) Int. Cl. H01M 8/04

(52) U.S. Cl. 429/429; 429/441

(57) ABSTRACT

Features is a fuel cell system including: a stack consisting of a plurality of unit cells generating electrical energy by means of electrochemical reaction of a fuel and an oxidizing agent; a fuel supply connected to the stack through a first connecting line to supply the fuel to the stack; an oxidizing agent supply connected to the stack through a second connecting line to supply the oxidizing agent to the stack; a burner mounted on the second connecting line and generating heat by means of oxidizing catalytic reaction of the fuel and oxidizing agent; a mixing valve mounted on a third connecting line which connects the first connecting line with the second connecting line and supplying the fuel and the oxidizing agent to the burner; and a heater mounted at the burner, generating heat by electricity, and supplying the heat to the burner.

### CROSS-REFERENCE TO RELATED APPLICATION

This application claims priority to and the benefit of Korean Patent Application No. 10-2009-0120086 filed in the Korean Intellectual Property Office on Dec. 04, 2009, the entire contents of which are incorporated herein by reference.

### BACKGROUND OF THE INVENTION

(a) Field of the Invention

The present invention relates to a fuel cell system and a control method of the same. More particularly, the present invention relates to a fuel cell system and a control method of the same which improve cold-startability of a fuel cell vehicle.

(b) Description of the Related Art

A fuel cell system is well known in the arts for use as an electric generator system which converts chemical energy of a fuel directly into electrical energy.

The fuel cell system largely includes a fuel cell stack that generates electrical energy, a fuel supply that supplies a fuel (e.g., hydrogen) to the fuel cell stack, an air supply that supplies oxygen (in air) which is an oxidizing agent of the electrochemical reaction of the fuel cell stack, and a device for managing heat and water radiating reaction heat of the fuel cell stack to an exterior of the system and controlling operating temperature of the fuel cell stack.

Such a fuel cell system generates electricity by the electrochemical reaction of the hydrogen (which is the fuel) and the oxygen in the air. Such a fuel system also exhausts heat and water which are by-products of the electrochemical reaction.

The fuel cell stack for use in a fuel cell vehicle includes a plurality of unit batteries that are arranged sequentially. Each unit battery includes a membrane-electrode assembly (MEA) disposed at the innermost part thereof. The membrane-electrode assembly includes an electrolyte membrane for transferring hydrogen ions and a catalytic layer, that is, a cathode and an anode, spread at both sides of the electrolyte membrane so the hydrogen reacts with the oxygen. Also includes is a separator that is formed of a flow field for supplying the fuel and the air to the cathode and the anode and exhausting water generated by a reaction. In addition, a gas diffusion layer (GDL) is positioned at an exterior portion of the membrane-electrode assembly (MEA), that is, the exterior portion in which the cathode and the anode are positioned. Also, the separator is positioned at an exterior of the gas diffusion layer.

The hydrogen and the oxygen are ionized by a chemical reaction at each catalytic layer such that the hydrogen undergoes an oxidation reaction so as to generate a hydrogen ion and an electron. The oxygen ion also undergoes a reduction reaction with the hydrogen ion which reaction generates water.

That is, since the hydrogen is supplied to the anode (alternatively, it is called “oxidation electrode”) and the oxygen (or air) is supplied to the cathode (alternatively, it is called “reduction electrode”), the hydrogen supplied to the anode is ionized into the hydrogen ion (H+) and the electron (e-) by the catalyst of an electrode layer formed at both sides of the electrolyte membrane. After that, only the hydrogen ion selectively passes through the electrolyte membrane which is a cation-exchange membrane, and is transferred to the cathode. Simultaneously, the electron (e-) is transferred to the cathode through the gas diffusion layer and the separator which are conductors.

The hydrogen ion, that is supplied to the cathode through the electrolyte membrane and the electron, that is supplied to the cathode by the separator, reacts with the oxygen in the air to generate water. At this time, current also is generated by flow of the electron through an exterior conducting wire caused by movement of the hydrogen ion. When the water is generated by the reaction, heat also occurs incidentally.

If a vehicle left is in a low temperature environment such as in the winter season when the ambient temperature is lower than 0° C., the inside of the stack is frozen by the ambient temperature. Thus, if one tries to start the vehivle in such conditions, the cold-starting is likely not to occur because of an inverse voltage.

One conventional method or technique for dealing with this is by using an external circuit to supply heat to the fuel cell. However, in using such methods or techniques, a balance between current output and cell voltage is required.

In another conventional method or technique, a gas mixture of hydrogen and oxygen is directly supplied to the anode or the cathode. In this way, the entire energy of the reaction gas and the water is converted into heat as the hydrogen and the oxygen are converted into the water. However, such a method or technique requires additional components such as a mixing chamber.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention features a fuel cell system and a control method for such a fuel cell, such a fuel cell and control method advantageously enhancing the cold-starting ability (hereinafter cold-startability) of a vehicle as a consequence of a gas mixture of a hydrogen and an oxygen is heated by a burner generating heat through an oxidizing catalytic reaction of the gas mixture, and entire temperature of a stack is raised by a reaction heat of the gas mixture in a unit battery.

According to an aspect of the present invention, such a fuel cell system includes a stack, a fuel supply, an oxidizing agent supply, a burner, a mixing valve and a heater. The stack includes a plurality of unit cells generating electrical energy by means of electrochemical reaction of a fuel and an oxidizing agent. The fuel supply is connected to the stack through a first connecting line so as to supply the fuel to the stack. The oxidizing agent supply is connected to the stack through a second connecting line so as to supply the oxidizing agent to the stack.

The burner is mounted on the second connecting line and generates heat by means of the oxidizing catalytic reaction of the fuel and the oxidizing agent. The mixing valve is mounted on a third connecting line which connects the first connecting line with the second connecting line and supplies the fuel and the oxidizing agent to the burner. The heater is mounted at the burner, generates heat by electricity, and supplies the heat to the burner.

In further embodiments, the fuel cell system further includes a temperature sensor that is mounted at the stack for, detecting temperature of the stack, and outputting a signal related to the detected temperature to a controller.

In further embodiments, the heater is electrically connected to a battery. Additionally, the fuel and the oxidizing agent heated by the burner is supplied to a cathode of the unit cell.

In further embodiments, the fuel cell system further includes a fourth connecting line that connects the first connecting line with the second connecting line at a location downstream of the burner.

In further embodiments, the fuel and the oxidizing agent heated by the burner is supplied to an anode of the unit cell through the fourth connecting line.

In further embodiments, the system includes a three-way valve for selectively closing/opening a hydraulic line of the fourth connecting line, which valve is mounted on the second connecting line downstream of the burner.

A fuel cell system according to another aspect of the present invention includes a stack, a fuel supply, an oxidizing agent supply, a first burner, a mixing valve, a second burner and a heater. The stack includes a plurality of unit cells generating electrical energy by means of electrochemical reaction of a fuel and an oxidizing agent. The fuel supply is connected to the stack through a first connecting line so as to supply the fuel to the stack. The oxidizing agent supply is connected to the stack through a second connecting line so as to supply the oxidizing agent to the stack.

The first burner is mounted on the second connecting line and generates heat by means of the oxidizing catalytic reaction of the fuel and the oxidizing agent. The mixing valve is mounted on a third connecting line which connects the first connecting line with the second connecting line and supplies the fuel and the oxidizing agent to the first burner. The heater is mounted at the first burner, generates heat by electricity, and supplies the heat to the first burner. The second burner is mounted at an exhaust side of a cathode of the stack, and removes the fuel and the oxidizing agent exhausted from the stack by means of an oxidizing catalytic reaction.

The present invention also features a control method for a fuel cell system according to the present invention. Such a control method includes detecting temperature of a stack; supplying a mixture of a fuel and an oxidizing agent to a burner when the temperature of the stack is higher than or equal to a first predetermined temperature, and supplying the heated mixture of the fuel and the oxidizing agent by the burner to the stack. Such a method also includes determining whether the temperature of the stack is higher than or equal to a second predetermined temperature; and normally operating the fuel cell system by separately supplying the fuel and the oxidizing agent to the stack when the temperature of the stack is higher than or equal to the second predetermined temperature.

In further embodiments, such a control method further includes preheating the burner by a heater, supplying the mixture of fuel and oxidizing agent to the burner, and supplying the heated mixture of the fuel and the oxidizing agent from the burner to the stack when the temperature of the stack is lower than the first predetermined temperature.

In further embodiments, the fuel is supplied to an anode of the stack, and the fuel and the oxidizing agent is supplied to a cathode of the stack.

In further embodiments, the fuel and the oxidizing agent are mixed by opening a mixing valve at the step and the mixing valve thereafter is closed.

In further embodiments, the mixture of the fuel and the oxidizing agent is supplied to the cathode of the stack when the temperature of the stack is lower than the second predetermined temperature.

In further embodiments, the fuel is supplied to the anode of the stack, and the mixture of the fuel and the oxidizing agent is supplied to the anode of the stack.

In further embodiments, the fuel is supplied to the anode of the stack, the fuel is supplied to the cathode of the stack, and the mixture of the fuel and the oxidizing agent is supplied to the cathode of the stack.

In further embodiments, the fuel is supplied to the anode of the stack, the fuel is supplied to the cathode of the stack, and the mixture of the fuel and the oxidizing agent is supplied to the anode of the stack.

In further embodiments, the fuel is supplied simultaneously to the anode and the cathode of the stack, and the mixture of the fuel and the oxidizing agent is supplied to the cathode of the stack.

In further embodiments, the fuel is supplied simultaneously to the anode and the cathode of the stack, and the mixture of the fuel and the oxidizing agent is supplied to the anode of the stack.

In further embodiments, the mixture of the fuel and the oxidizing agent is supplied simultaneously to the anode and the cathode of the stack.

Other aspects and embodiments of the present invention are described herein.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 is a block diagram of a fuel cell system having an enhanced cold-startability according to the present invention.

FIG. 2 is a high level flowchart illustrating a control method according to the present invention, for a fuel cell system having an enhanced cold-startability.

FIG. 3A to FIG. 3C are block diagrams for explaining a control method for a fuel cell system having enhanced cold-startability according to the present invention.

FIG. 4 is a block diagram of a fuel cell system having enhanced cold-startability according to an embodiment of the present invention.

FIG. 5 is a block diagram of a fuel cell system having enhanced cold-startability according to another embodiment of the present invention.

### DETAILED DESCRIPTION OF THE EMBODIMENTS

In aspects/embodiments of the present invention there is featured a fuel cell system that includes a stack, a fuel supply, an oxidizing agent supply, a burner and a mixing valve. The stack has a plurality of unit cells that generate electrical energy by means of an electrochemical reaction of a fuel and an oxidizing agent. The burner is configured to generate heat by means of an oxidizing catalytic reaction of the fuel and the oxidizing agent. The mixing valve is operably coupled to the fuel supply and the oxidizing agent supply so as to supply the fuel and the oxidizing agent to the burner. Also, the fuel and the oxidizing agent that are heated by the burner are supplied to the stack.

In further aspects/embodiments of the present invention such a fuel cell system further includes a heater mounted at the burner, that generates heat by electricity, and supplies the heat to the burner for preheating of the burner.

In yet further embodiments of the present invention such a fuel cell system further includes a first connecting line that is operably coupled to the fuel supply and the stack to supply the fuel to the stack and a second connecting line that is operably coupled to the oxidizing agent supply and the stack to supply the oxidizing agent to the stack. Such a fuel cell system also includes a third connecting line in which is disposed the mixing valve and which connects the first connecting line with the second connecting line and supplies the fuel and the oxidizing agent to the burner. Also, in such an embodiment, the burner is fluidly coupled to the second connecting line.

In yet further embodiments/aspects of the present invention, such a fuel cell system includes a second burner that is mounted at an exhaust side of a cathode of the stack to remove the fuel and the oxidizing agent exhausted from the stack by means of an oxidizing catalytic reaction.

The following more particularly describes the fuel cell systems and control methods of the present invention. As recognized by those skilled in the art, described systems and methods are adaptable or modifiable in any of a number of different ways, all without departing from the spirit or scope of the present invention.

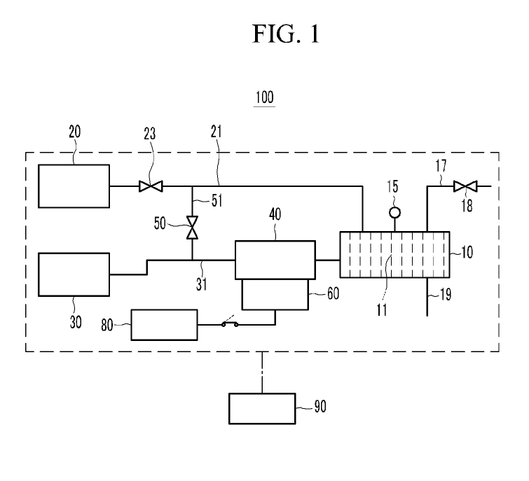

Now referring to FIG. 1, there is shown a block diagram of a fuel cell system 100 according to the present invention having enhanced cold-startability. In more particular embodiments, such a fuel cell system 100 is provided in a fuel cell vehicle and is operated as an electric generator system which generates electrical energy by an electrochemical reaction of a fuel and an oxidizing agent.

When the fuel cell system 100 is a direct oxidation fuel cell, the fuel includes alcoholic liquid fuel such as methanol and ethanol and hydrocarbon family liquefied gas fuel, the chief ingredients of which are methane, ethane, propane, and butane. When the fuel cell system 100 is a polymer electrolyte membrane fuel cell, the fuel includes reforming gas generated from the liquid fuel or liquefied gas fuel by a reformer.

In particular illustrative embodiments, the oxidizing agent is oxygen gas. In further embodiments the oxygen is stored in a special tank(s), either in gaseous or liquefied form, or the oxygen is that naturally contained in air, which is obtained from the surrounding environment or is stored in a special tank(s). For convenience and for simplification, reference to air will be made hereinafter when referring to the oxidizing agent.

As described herein, the fuel cell system 100 of the present invention is capable of raising the temperature of the stack 10 so as to be higher than a predetermined temperature, for example 0° C. so as to thereby improve the cold-startability of the stack and thus the vehicle. In this way, when a vehicle is left in a low temperature such a in winter season when the ambient temperature is lower than 0° C., the fuel cell system 100 is startable.

The fuel cell system 100 according to an aspect of the present invention includes the stack 10, a fuel supply 20, an air supply 30, a burner 40, a mixing valve 50, a heater 60, and a controller 90, and each components will be described in detail.

The stack 10 includes a plurality of unit cells 11 that are sequentially arranged. Each unit cell 11 generates electrical energy through electrochemical reaction of fuel and air. In particular embodiments, each unit cell 11 is a polymer electrolyte membrane fuel cell or a direct oxidation fuel cell according to the fuel used therein. The unit cell 11 also includes a membrane-electrode assembly (MEA) and a couple of separators contactedly disposed to both sides of the membrane-electrode assembly.

Each separator has a plate shape and has conductivity. The separator also is provided with a channel for flowing the fuel and the air to a surface closely contacted with the membrane-electrode assembly.

An anode electrode (hereinafter, for convenience it will be called “anode”) is provided at one surface of the membrane-electrode assembly, and a cathode electrode (hereinafter, for convenience it will be called “cathode”) is provided at the other surface of the membrane-electrode assembly. Also, an electrolyte membrane is provided between the anode and the cathode.

The anode ionizes the fuel supplied through the channel of the separator into an electron and a hydrogen ion by an oxidation reaction, and the electrolyte membrane moves the hydrogen ion to the cathode. In addition, the cathode generates water and heat though a reduction reaction of the electron and the hydrogen ion supplied from the anode and the oxygen in the air supplied through the channel of the separator.

The fuel cell system 100 further includes a temperature sensor 15 that is provided at the stack 10. The temperature sensor 15 detects temperature of the stack 10 and outputs a detection signal corresponding thereto to the controller 90.

The stack 10 further includes a purge line 17 that is connected to the anode of the unit cells 11, a purge valve 18 that is mounted on the purge line 17, and an air exhaust line 19 that exhausts the water generated at the unit cells 11 and the air that is not reacted.

The fuel supply 20 is connected to the stack 10 through a first connecting line 21. In this way, the fuel supply 20 supplies the fuel to the anode of the unit cells 11 in the stack 10 via the first connecting line.

The first connecting line 21 is configured so as to include an opening/closing valve 23 that is operable to selectively open/close the fkuid passage in the connecting line 21 according to a control signal from the controller 90.

The air supply 30 includes a conventional air blower and is connected to the stack 10 through a second connecting line 31. In this way, the air supply 30 supplies the air to the cathode of the unit cells 11 in the stack 10 via the second connecting line according to a control signal from the controller 90.

The burner 40 receives the fuel supplied from the fuel supply 20 and the air supplied from the air supply 30 by an operation of the mixing valve 50 and generates heat through an oxidizing catalytic reaction of the fuel and the air.

The burner 40 includes an oxidizing catalyst in a small burner container and generates heat through the oxidizing catalytic reaction of the fuel and the air occurring when the temperature of the burner 40 is higher than or equal to a predetermined threshold temperature. In particular embodiments, the heat is generated with a constant temperature. The oxidizing catalyst causes the oxidizing catalytic reaction.

The burner 40 is fluidly coupled to the second connecting line 31. The burner generates the heat through the oxidizing catalytic reaction of the fuel and the air and supplies remaining fuel and air heated by the heat to the cathode of the unit cells 11 through the second connecting line 31.

Such a burner 40 is any of a number of catalytic burners as are known to those skilled in the art. In view of this, a detailed description of the catalytic burner is not provided herein.

The mixing valve 50 mixes the fuel supplied from the fuel supply 20 with the air supplied from the air supply 30 and supplies them to the burner 40.

The mixing valve 50 is fluidly coupled to a third connecting line 51 which connects the first connecting line 21 with the second connecting line 31. In particular embodiments, the mixing valve 50 is any of a number of valves known to those skilled in the art that can selectively open/close the fluid passage of the third connecting line 51 according to a control signal from the controller 90.

If the temperature of the burner 40 is low, the oxidizing catalyst cannot cause the oxidizing catalytic reaction. In further embodiments, the fuel cell system 100 includes a heater 60 that supplies heat, the temperature of which is higher than the predetermined threshold temperature, to the burner 40. Such heat is provided to activate the oxidizing catalyst.

The heater 60 is mounted at the burner 40. In further embodiments, the heater is electrically connected to a battery 80 so that the heat is generated electrically.

The controller 90 controls operation of the fuel cell system 100 such as by outputting a control signal(s) to the functionalities of the fuel cell system. In more particular embodiments, the controller 90 controls operations of the valves 23 and 50 and the heater 60.

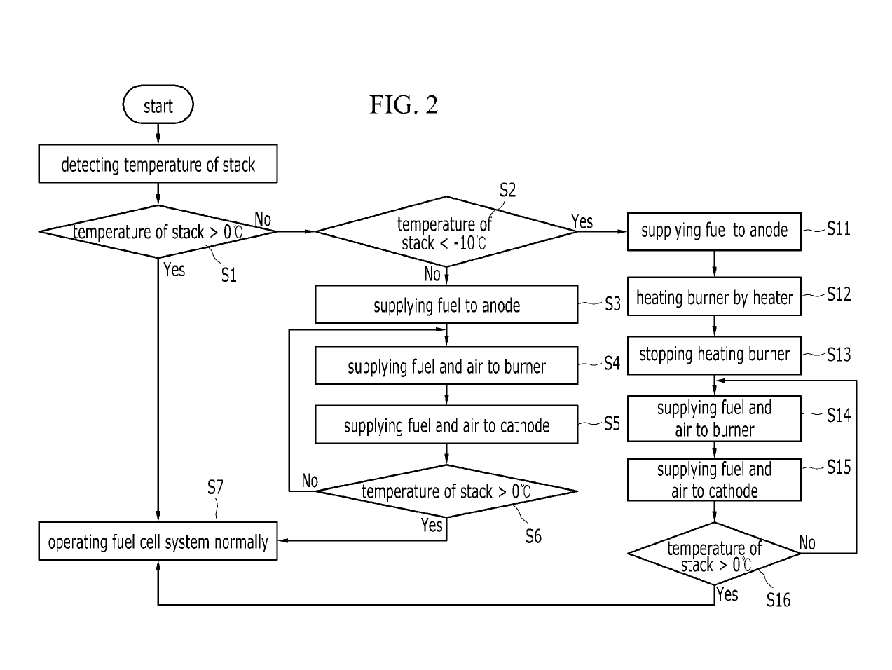

In another aspect of the present invention, there is featured a control method for such a fuel cell system 100 which will be described in detail with reference to the accompanying drawings. Reference also should be made to FIG. 1 for the cell system functionalities referred to in the following discussion. Referring now to FIG. 2 there is shown a high level flow diagram or flowchart showing a control method for a fuel cell system having an enhanced cold-startability.

According to the method, when a driver turns a starting key to on-state so as to run a vehicle, the controller 90 determines whether a cold-starting condition of the vehicle is satisfied through a temperature signal of the stack 10 received from the temperature sensor 15.

That is, in order to determine whether the cold-starting condition of the vehicle is satisfied, the controller 90 determines whether the temperature of the stack 10 is lower than 0° C. at step S1 and whether the temperature of the stack 10 is higher than or equal to a first predetermined temperature (about −10° C.) at step S2.

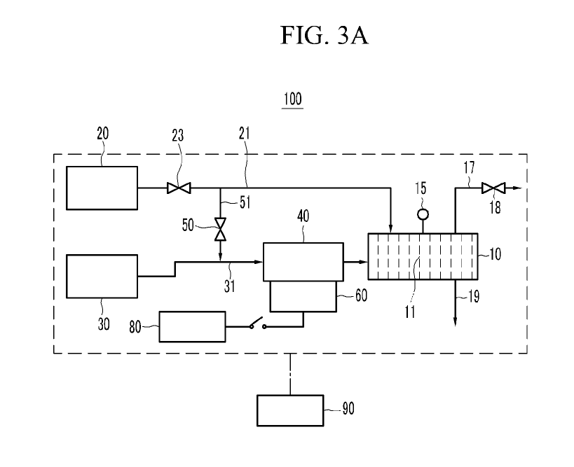

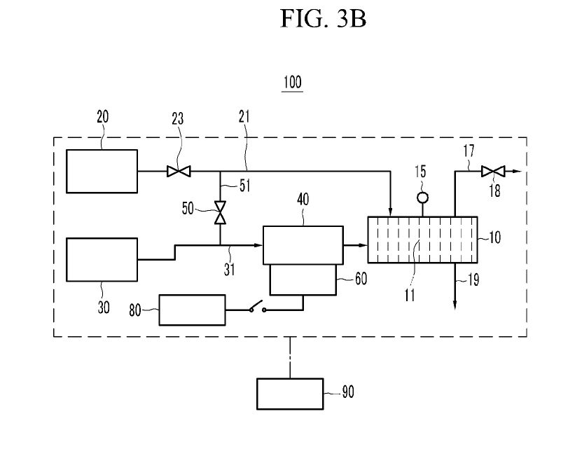

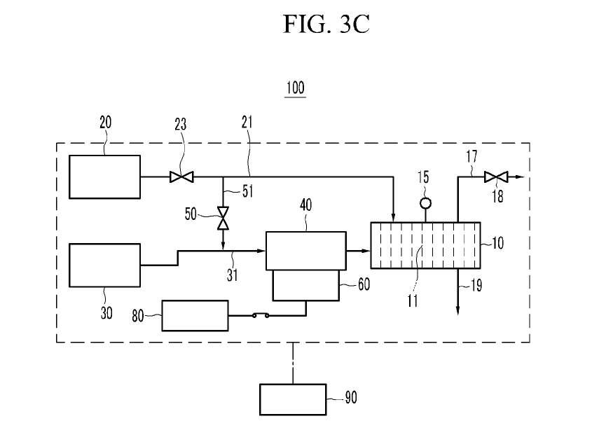

If it is determined that the temperature of the stack is lower than 0 and higher than or equal to the first predetermined temperature at steps S1 and S2, the fuel supply 20, as shown in FIG. 3A, supplies the fuel to the stack 10. In such a case, the opening/closing valve 23 is opened and the fuel is supplied through the first connecting line 21 to the anode of the unit cells 11 at step S3.

After that, the controller 90 transmits the control signal to the mixing valve 50 so as to open the third connecting line 51, and operate the air supply 30.

Then, a part of the fuel supplied from the fuel supply 20 and the air supplied from the air supply 30 are mixed in the second connecting line 31, and a mixture of the fuel and the air is supplied to the burner 40 at step S4.

After that, a part of the fuel and the air undergoes an oxidizing catalytic reaction by the oxidizing catalyst such that the burner 40 generates the heat. The remaining fuel and the air is heated by the heat generated in the burner 40 and is supplied to the cathode of the unit cells 11 at step S5.

Since the fuel and the air supplied to the cathode of the unit cells 11 is heated in the burner 40, the temperature of the catalyst at an inlet portion of the cathode rises quickly, and the temperature of the entire cathode rises gradually by the heat generated through the reduction reaction of the hydrogen in the fuel and the oxygen in the air. Consequently, the temperature of the entire stack 10 will rise.

After that, the controller 90 receives a detection signal corresponding to the temperature of the stack 10 from the temperature sensor 15 and determines whether the temperature of the stack 10 is higher than or equal to 0° C. at step S6.

If it is determined that the temperature of the stack 10 is higher than or equal to 0° C. at the step S6, the fuel cell system 100 is operated normally at step S7. That is, the controller 90 controls the mixing valve 50 to close the third connecting line 51 as shown in FIG. 3B, so the fuel is supplied from the fuel supply 20 to the anode of the unit cells 11 through the first connecting line 21 and the air is supplied from the air supply 30 to the cathode of the unit cells 11 through the second connecting line 31. Thereafter, electrical energy is generated in the unit cells 11 of the stack 10 through an electrochemical reaction of the hydrogen in the fuel and the oxygen in the air.

If the controller determines that the temperature of the stack 10 is lower than 0° C. at step S6, then steps S3 to S6 are repeated.

If it is determined that the temperature of the stack 10 is lower than 0° C. at step S1 and is lower than the first predetermined temperature (about −10° C.) at step S2, the fuel supply 20 supplies the fuel to the stack 10 as shown in FIG. 3C. That is, the opening/closing valve 23 is opened, and the fuel is supplied to the anode of the unit cells 11 through the first connecting line 21 at step S11.

After that, the controller 90 supplies electricity from the battery 80 to the heater 60. The heater 60 generates the heat from the electricity and supplies the generated heat to the burner 40 at step S12. After that, when the burner 40 is heated up to the predetermined threshold temperature by the heater 60, the controller 90 stops the supply of the electricity from the battery 80 to the heater 60 at step S13.

After that, the controller 90 applies a control signal to the mixing valve 50 so as to open the third connecting line 51 and operates the air supply 30. A part of the fuel supplied from the fuel supply 20 and the air supplied from the air supply 30 are then mixed in the second connecting line 31 and are supplied to the burner 40 at step S14. A part of the fuel and the air undergoes the oxidizing catalytic reaction in the burner 40 by the oxidizing catalyst so as to generate the heat. The remaining fuel and air is heated by the generated heat and is supplied to the cathode of the unit cells 11 at step S15.

As the fuel and the air supplied to the cathode of the unit cells 11 is heated by the burner 40, the temperature of the catalyst at an inlet portion of the cathode rises quickly, and the temperature of the entire cathode rises gradually by the heat generated through the reduction reaction of the hydrogen in the fuel and the oxygen in the air. Consequently, the temperature of the entire stack 10 will rise.

After that, the controller 90 receives a detection signal corresponding to the temperature of the stack 10 from the temperature sensor 15 and determines whether the temperature of the stack 10 is higher than or equal to 0□ at the step S16.

If it is determined that the temperature of the stack 10 is higher than or equal to 0° C. at step S16, the fuel cell system 100 is operated normally at step S7. The normal operation of the fuel cell system 100 is described with specific reference to FIG. 3B.

If the controller 90 determines that the temperature of the stack 10 is lower than 0° C. at step S16, then steps S13 to S16 are repeated.

As the temperature of the stack 10 is raised up to a predetermined value when a vehicle left in a low temperature is cold-started in a winter season, using the methods and systems of the present invention, the cold-startability of the vehicle is improved.

In other words, as s the fuel and the air supplied to cathode of the unit cells 11 is heated by the heat generated in the burner 40 through the oxidizing catalytic reaction of the fuel and the air, the temperature of the stack 10 s raised in a cold-starting condition of the vehicle, the temperature of the entire stack 10 rises quickly by the heat generated though the reduction reaction of the hydrogen in the fuel and the oxygen in the air at the cathode of the unit cells 11.

Therefore, the present invention has an advantage of easily melting the entire stack 10 when cold-starting of the vehicle as a result og the fuel and the air being heated by the burner 40 that are supplied to the cathode of the unit cells 11 and heat generated in the unit cells 11 through chemical reaction is evenly supplied to the entire stack 10.

In addition, the present invention differs from a conventional type where the stack is heated by a current output from the unit cells 11 enables of cold-starting by the chemical reaction. Because of such a difference, in the present invention there is no need to meet a balance of a current and a cell voltage. Also as a mixing chamber for mixing the fuel and the air and supplying them to the cathode of the unit cells 11 is not provided in the present invention, the entire system 100 can be simplified.

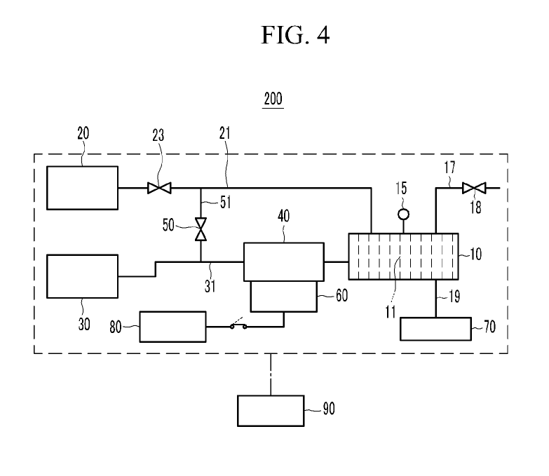

Referring to FIG. 4 there is shown a block diagram of a fuel cell system having an enhanced cold-startability according to another embodiment of the present invention.

A fuel cell system 200 according to this embodiment is similar to the fuel cell system 100 shown in FIG. 1. Accordingly, reference shall be made to the discussion regarding FIG. 1 for details of functionalities not otherwise described hereinafter. It also is within the scope of the present invention to use the control methodology described in connection with FIG. 2 in connection with the fuel cell system 200 of the another embodiment.

The fuel cell system 200 of this embodiment includes a burner 40 (for convenience, it will be called “the first burner”) for heating the fuel and the oxidizing agent supplied to the stack 10 and a second burner 70 mounted at an exhaust side of the cathode of the stack 10.

The second burner 70 has the same structure as the first burner 40 and removes a gas mixture of the fuel and the oxidizing agent that did not react in the cathode of the stack 10 and is being exhausted therefrom through an oxidizing catalytic reaction.

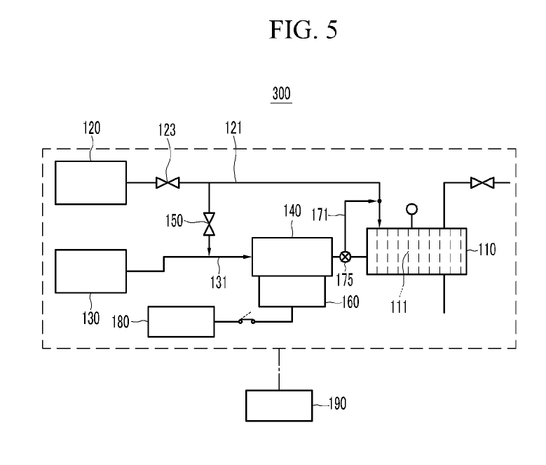

Referring now to FIG. 5, there is showna block diagram of a fuel cell system 300 having an enhanced cold-startability according to yet another embodiment of the present invention.

Referring to the drawings, a fuel cell system 300 according to this embodiment of the present invention is similar to the fuel cell system 100 shown in FIG. 1. Accordingly, reference shall be made to the discussion regarding FIG. 1 for details of functionalities not otherwise described hereinafter. It also is within the scope of the present invention to use the control methodology described in connection with FIG. 2 in connection with the fuel cell system 200 of the another embodiment.

The fuel cell system 300 according to this embodiment, includes a fourth connecting line 171 which connects the first connecting line 121 with the second connecting line 131 at a downstream of the burner 140. That is, the fuel and the oxidizing agent heated in the burner 140 is supplied to the anode of the unit cells 111 through the fourth connecting line 171.

The fuel cell system includes a three-way valve 175 for selectively opening/closing a fluid passage of the fourth connecting line 171 and is disposed in the second connecting line 131 downstream of the burner 140.

With such an arrangement, the fuel supplied from the fuel supply 120 and the air supplied from the air supply 130 are mixed by the mixing valve 150 and are supplied to the burner 140 when cold-starting condition of the vehicle.

Heat is generated in the burner 140 through the oxidizing catalytic reaction of a part of the fuel and the air, and the remaining fuel and air heated in the burner 140 is supplied to the anode of the unit cells 111 in the stack 110 through the fourth connecting line 171 by the three-way valve 175.

If it is determined that the temperature of the stack 110 is lower than 0° C. and also is lower than the first predetermined temperature (about −10° C.), the controller 190 applies the electricity of the battery 180 to the heater 160 and the heat generated in the heater 160 is supplied to the burner 140.

Accordingly, the hydrogen in the fuel and the oxygen in the air undergo the reduction reaction in the stack 110, and thereby the heat is generated. Therefore, the temperature of the entire stack 110 is raised.

The controller 190 according to the present embodiment controls the mixing valve 150 and the three-way valve 175 so as to improve the cold-startability of the vehicle. The control method performed by the controller 190 is as follows.

After the fuel is supplied to the anode of the stack 110, the fuel is supplied to the cathode of the stack 110 and the fuel and the oxidizing agent passing though the burner 140 are supplied to the cathode of the stack 110.

After the fuel is supplied to the anode of the stack 110, the fuel is supplied to the cathode of the stack 110 and the fuel and the oxidizing agent passing though the burner 140 are supplied to the anode of the stack 110.

Also, after the fuel is supplied simultaneously to the anode and the cathode of the stack 110, the fuel and the oxidizing agent passing though the burner 140 are supplied to the cathode of the stack 110.

In addition, after the fuel is supplied simultaneously to the anode and the cathode of the stack 110, the fuel and the oxidizing agent passing through the burner 140 are supplied to the anode of the stack 110.

In addition, the fuel and the oxidizing agent passing through the burner 140 is supplied simultaneously to the anode and the cathode of the stack 110.

As the fuel and air supplied to a cathode of unit cells raise the temperature of a stack in a cold-starting condition and the unit cells are heated through an oxidizing catalytic reaction in a burner, a reduction reaction of hydrogen in the fuel and oxygen in the air can quickly occur in the cathode of the unit cells. In addition, temperature of entire stack can rise quickly due to heat generated through the reduction reaction of hydrogen and oxygen in the cathode of the unit cells.

Therefore, the present embodiment has an advantage of easily melting the entire stack when cold-starting of the vehicle because the fuel and the air heated by the burner are supplied to the cathode of the unit cells and the heat generated in the unit cells through chemical reaction is evenly supplied to the entire stack.

In addition, the fuel cell system of the present embodiment is different from a conventional type where the stack is heated by a current output from the unit cells enables of cold-starting by the chemical reaction. Therefore, in the present embodiment there is no need to meet a balance of a current and a cell voltage. also, as a mixing chamber for mixing the fuel and the air and supplying them to the cathode of the unit cells is not needed in the present embodiment, the entire fuel cell system of the present embodiment is simplified.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fuel cell system comprising:
a stack having a plurality of unit cells that generate electrical energy by means of an electrochemical reaction of a fuel and an oxidizing agent;
a fuel supply that is connected to the stack through a first connecting line to supply the fuel to the stack;
an oxidizing agent supply that is connected to the stack through a second connecting line to supply the oxidizing agent to the stack;
a burner fluidly coupled to the second connecting line and being configured to generate heat by means of oxidizing catalytic reaction of the fuel and the oxidizing agent;
a mixing valve disposed in a third connecting line which connects the first connecting line with the second connecting line and supplying the fuel and the oxidizing agent to the burner; and
a heater mounted at the burner, that generates heat by electricity, and supplies the heat to the burner.

2. The fuel cell system of claim 1, further comprising a temperature sensor coupled to the stack, the sensor being configured to detect temperature of the stack, and output a signal related to the detected temperature to a controller.

3. The fuel cell system of claim 1, wherein the heater is electrically connected to a battery.

4. The fuel cell system of claim 1, wherein the fuel and the oxidizing agent that are heated by the burner are supplied to a cathode of the unit cell.

5. The fuel cell system of claim 1, further comprising:
a fourth connecting line for connecting the first connecting line with the second connecting line at a downstream of the burner; and
wherein the fuel and the oxidizing agent that are heated by the burner are supplied to an anode of the unit cell through the fourth connecting line.

6. The fuel cell system of claim 5, further comprising a three-way valve for selectively closing/opening a fluid passage of the fourth connecting line, the three-way-valve being disposed in the second connecting line downstream of the burner.

7. A fuel cell system comprising:
a stack having a plurality of unit cells generating electrical energy by means of an electrochemical reaction of a fuel and an oxidizing agent;
a fuel supply that is connected to the stack through a first connecting line to supply the fuel to the stack;
an oxidizing agent supply that is connected to the stack through a second connecting line to supply the oxidizing agent to the stack;
a first burner fluidly coupled to the second connecting line and generating heat by means of an oxidizing catalytic reaction of the fuel and the oxidizing agent;
a mixing valve disposed in a third connecting line which connects the first connecting line with the second connecting line and supplies the fuel and the oxidizing agent to the first burner;
a heater mounted at the first burner, he heater generating heat by electricity, and supplying the generated heat to the first burner; and
a second burner mounted at an exhaust side of a cathode of the stack to remove the fuel and the oxidizing agent exhausted from the stack by means of an oxidizing catalytic reaction.

8. A control method of a fuel cell system for improving cold-startability of a fuel cell vehicle, the method comprising the step(s) of:
a) detecting temperature of a stack;
b) supplying a mixture of a fuel and an oxidizing agent to a burner when the temperature of the stack is higher than or equal to a first predetermined temperature, and
c) supplying the heated mixture of the fuel and the oxidizing agent by the burner to the stack;
d) determining whether the temperature of the stack is higher than or equal to a second predetermined temperature; and
e) normally operating the fuel cell system by separately supplying the fuel and the oxidizing agent to the stack when the temperature of the stack is higher than or equal to a second predetermined temperature.

9. The control method of claim 8, wherein the burner is preheated by a heater, the mixture of the fuel and the oxidizing agent is supplied to the burner, and the mixture of the fuel and the oxidizing agent heated by the burner are supplied to the stack when the temperature of the stack is lower than the first predetermined temperature.

10. The control method of claim 8, wherein a fuel is supplied to an anode of the stack, and the fuel and the oxidizing agent are supplied to a cathode of the stack.

11. The control method of claim 8, wherein the fuel and the oxidizing agent are mixed by opening a mixing valve and thereafter closing the mixing valve.

12. The control method of claim 8, wherein the mixture of the fuel and the oxidizing agent is supplied to the cathode of the stack when the temperature of the stack is lower than the second predetermined temperature.

13. The control method of claim 8, wherein the fuel is supplied to the anode of the stack, and the mixture of the fuel and the oxidizing agent is supplied to the anode of the stack.

14. The control method of claim 8, wherein the fuel is supplied to the anode of the stack, the fuel is supplied to the cathode of the stack, and the mixture of the fuel and the oxidizing agent is supplied to the cathode of the stack.

15. The control method of claim 8, wherein the fuel is supplied to the anode of the stack, the fuel is supplied to the cathode of the stack, and the mixture of the fuel and the oxidizing agent is supplied to the anode of the stack.

16. The control method of claim 8, wherein the fuel is supplied simultaneously to the anode and the cathode of the stack, and the mixture of the fuel and the oxidizing agent is supplied to the cathode of the stack.

17. The control method of claim 8, wherein the fuel is supplied simultaneously to the anode and the cathode of the stack, and the mixture of the fuel and the oxidizing agent is supplied to the anode of the stack.

18. The control method of claim 8, wherein the mixture of the fuel and the oxidizing agent is supplied simultaneously to the anode and the cathode of the stack.

19. A fuel cell system comprising:
a stack having a plurality of unit cells that generate electrical energy by means of an electrochemical reaction of a fuel and an oxidizing agent;
a fuel supply;
an oxidizing agent supply;
a burner being configured to generate heat by means of an oxidizing catalytic reaction of the fuel and the oxidizing agent;
a mixing valve operably coupled to the fuel supply and the oxidizing agent supply so as to supply the fuel and the oxidizing agent to the burner; and
wherein the fuel and the oxidizing agent that are heated by the burner are supplied the stack.

20. The fuel cell system of claim 19, further comprising a heater mounted at the burner, that generates heat by electricity, and supplies the heat to the burner for preheating of the burner.

21. The fuel cell system of claim 19, further comprising:
a first connecting line that is operably coupled to the fuel supply and the stack to supply the fuel to the stack;
a second connecting line that is operably coupled to the oxidizing agent supply and the stack to supply the oxidizing agent to the stack;
a third connecting line in which is disposed the mixing valve and which connects the first connecting line with the second connecting line and supplies the fuel and the oxidizing agent to the burner; and
wherein the burner is fluidly coupled to the second connecting line.

22. The fuel cell system of claim 19, further comprising:
a second burner that is mounted at an exhaust side of a cathode of the stack to remove the fuel and the oxidizing agent exhausted from the stack by means of an oxidizing catalytic reaction.
